(19) United States
(12) Patent Application Publication
(10) Pub. No.: US 2003/0155780 A1
(43) Pub. Date: Aug. 21, 2003

(54) Closing device for a vehicle door

(76) Inventors: Rolf Bucker, Coburg (DE); Thomas Flecke, Bamberg (DE); Gerhard Hofmann, Untersiemau (DE)

Correspondence Address: CHRISTIE, PARKER & HALE, LLP, 350 WEST COLORADO BOULEVARD, SUITE 500, PASADENA, CA, 91105, US

(21) Appl. No.: 10/344,299

(22) PCT Filed: Aug. 9, 2001
(86) PCT No.: PCT/DE01/03036

(30) Foreign Application Priority Data
Aug. 11, 2000 (DE) 100 41 498.2

(51) Int. Cl. E05B 3/00

(52) U.S. Cl. 292/336.3

(57) ABSTRACT

The invention relates to a closing device for a vehicle door, comprising a doorlock, an operating element (4), for operating the doorlock, an external door handle (1), fixed to the external skin (100) of the vehicle door with an adjuster piece (15), a deflecting element (2) which translates a movement of the adjuster piece (15) along a first direction (R) into a movement along a second direction (B) and a coupling element (3) by means of which the deflector element (2) acts upon the operating element (4). According to the invention, the external door handle (1) and the deflecting element (2) are connected to the external skin (100) of the vehicle door, such that they move together with a deformation of the external skin (100) and that the coupling element (3) is provided with means (5) for distance compensation, which permits a movement of the deflector piece (2) relative to the operating element (4), without the deflecting element (2) acting upon the operating element.

### DESCRIPTION

The invention relates to a closing device for a vehicle door with a door lock, with at least one actuating element for operating the door lock, with an external door actuator which is fixed on the outer skin of the vehicle door and which has an adjuster part which moves along a first direction when the external door actuator is operated, as well as with a force transfer device through which the adjuster part of the external door actuator is coupled to the actuating element.

With a closing device of this kind the external door actuator normally comprises an external door handle which is coupled through the force transfer device to an operating element of the door locking in the form of an operating lever. If the door lock is in the unlocked state (e.g. because it has previously been unlocked by a key or remote control) then the door can be opened by means of the external handle whereby the external handle acts on the door lock through the force transfer device and the operating lever. The operating lever thus interacts with the door lock so that when the door lock is unlocked the door can be opened by means of the external door handle.

The problem exists here however that any deformation to the external door skin caused by a crash and transferred to the operating lever would bring the risk of unintended opening of the door in a crash situation.

From DE 197 44 384 A1 a closing device is known for a vehicle door which has a lock with release lever (operating lever) fixed on the inner panel of the vehicle door, and an external door actuator which acts on the release lever through a force transfer element. In order to prevent deformations of the door caused by a crash transferring to the release lever the force transfer element is formed as a Bowden cable with excess length. This known closing device has the drawback however that the Bowden cable does not occupy a defined position inside the vehicle door because of its excess length.

For a defined guidance of the Bowden cable inside the vehicle door it would therefore be necessary to fix this by means of additional clips. For this purpose the Bowden cable must however be accessible from the interior of the vehicle. This limits the flexibility considerably when assembling the vehicle door. An example here would be fitting the vehicle door where several functional components of the door, such as the door lock and window lever are prefitted on a door module support. Should this door module support be fixed on the inner skin of the vehicle door before the external door actuator is attached to the outer skin and connected to the door lock then there would not be sufficient access to the Bowden cable from inside the door.

The U.S. Pat. No. 3,848,909 describes an operating device for a motor vehicle lock which has a coupling rod for coupling an operating handle to a lever mechanism. The coupling rod is mounted for swivel movement on the side of the operating handle. On the side of the lever mechanism the coupling rod is guided with an engagement element in an oblong hole mounted in the lever mechanism and serving to compensate tolerances.

The object of the invention is therefore to provide a closing device for motor vehicles which rules out the unintended release of the operating element of the lock coupled to the external door actuator in the event of deformation to the external door skin and at the same time eliminates the disadvantages described above.

This is achieved according to the invention by providing a closing device which has the features of patent claim 1.

According to this, the closing device has at least one deflector element which converts movement of the adjuster part which is movable together with the external door actuator, into a movement along another direction (and thereby preferably undertakes a translation function at the same time), as well as furthermore a coupling element through which the deflector element acts on the operating element of the door lock which is coupled to the external door actuator. The deflector element is hereby in (direct or indirect) connection with the outer skin of the vehicle door in the region of the external door actuator so that in the event of deformation of the region of the external skin on which the external door actuator is mounted the deflector element is moved together with the external door actuator; and the coupling element is provided with means for compensating the spacing, or interacts with these means which, if the position of the deflector element changes as a result of deformation of the external skin, enable a movement of the deflector element relative to the operating element without the deflector element acting through operating element on the door lock so that the vehicle door opens.

The solution according to the invention has the advantage that the deflector element can be attached defined in the region of the external door actuation on the outer skin of the vehicle door. This deflector element is in turn readily coupled by a coupling element to the operating element of the door lock and thus to the door lock itself. The distance compensating means thereby ensure that in the event of deformation to the external door skin the deflector element (together with the external door actuator) can move relative to the operating element of the lock without causing the door to open.

Furthermore the solution according to the invention is characterised in that it enables a flexible fitting, more particularly in the case of vehicle doors in which fitting is carried out by using a door module. These advantages are furthermore explained below in connection with the description of preferred variations of the invention using the sub-claims and the figures of the drawings.

The means provided according to the invention for compensating the distance can moreover not only become active in a crash situation but can also serve as means for tolerance compensation during fitting of the door lock; they then undertake a double function. For the significance of the tolerance compensation when fitting a door lock reference is made to DE 196 19 869 A1.

In order to achieve the external door actuation and the deflector element moving together if the external door skin is deformed the external door actuator and the deflector element can be connected through a common structural door group to the external skin of the vehicle door which can also serve as a supporting part of the external door actuator and deflector element. A structural door group of this kind can be in particular a socket for the external door actuator, which comprises for example a grip indent and bearing socket.

The deflector element and coupling element are preferably formed by separate interconnected components or groups in which the deflector element is for example a rigid swivel mounted component part.

In one embodiment a pulling movement is converted or reversed into a pushing movement through the deflector element. The deflector element can be in this case an at least double-armed lever in which the adjusting part of the external door actuator engages on the one arm, and the coupling element e.g. in the form of a coupling rod engages on the other arm.

In another embodiment the deflector element is provided for converting linear movement of the adjuster part of the external door actuator into a rotary movement. Particularly suitable for this is a deflector element in the form of a roller which interacts with the adjuster part in the manner of a toothed rod gearing or which has a curved guide slide in which a guide element of the adjuster part engages for generating a rotating movement.

The roller can advantageously be formed as a winder element on which a coupling element in the form of a wind-up tension member can be wound and unwound.

On the other hand the roller can be provided for holding a coupling element rotationally secured which rotates together with the roller and in this way acts on the operating element of the door lock. The operating element is in this case formed as a lock follower.

The arrangement of the deflector element in the region of the external actuator is preferably such that the deflector element moves together with the external actuator should the exterior skin of the vehicle door become compressed through a crash (e.g. in the event of a front impact crash).

The distance compensating means can be designed both so that they permit movement of the deflector element relative to the operating element of the door lock along one direction, and also so that they enable movement of the deflector element relative to the operating element along two substantially opposite directions.

It can thus be proposed by way of example that the distance compensating means permit a movement of the deflector element relative to the operating element of the door lock only in the direction of the space outside of the vehicle. This is then advisable if the exterior skin of the vehicle door is designed so that in crash situations which are graded particularly critical the exterior skin of the vehicle door deforms uniformly outwards in the region of the deflector element and external door actuator.

In other cases it is advantageous if the distance compensating means permit movement of the deflector element relative to the operating element of the door lock both in the direction of the space above the vehicle and in the direction of the interior of the vehicle.

According to one variation of the invention the distance compensating means are mounted between the coupling element and the actuating element of the door lock. The coupling element and the operating element can hereby interact through positive locking elements in the manner of a detent or ratchet coupling, e.g. through inclined teeth which permit a movement of the coupling element relative to the operating element in the direction of the exterior space of the vehicle whilst during movement of the coupling element in the opposite direction the operating element is entrained along.

According to a further variation of the invention the distance compensation is undertaken by the interaction of the deflector element with the coupling element. To this end a coupling element can be wound up in the manner of a wind-up tension member onto a deflector element in the form of a winding element so that during movement of the winding element in the direction of the exterior space of the motor vehicle the coupling element can be unwound. Since a coupling element formed as a wind-up element (e.g. as a cable) can only transfer traction forces and not pushing forces this also enables a movement of the deflector element relative to the operating element of the door lock in the direction of the vehicle interior without the operating element causing the door to open.

Finally there is also the possibility that the distance compensating means are directly integrated in the coupling element, e.g. by the coupling element having a telescopic design.

Further features and advantages of the invention will now be explained with reference to the embodiments illustrated in the drawings in which:

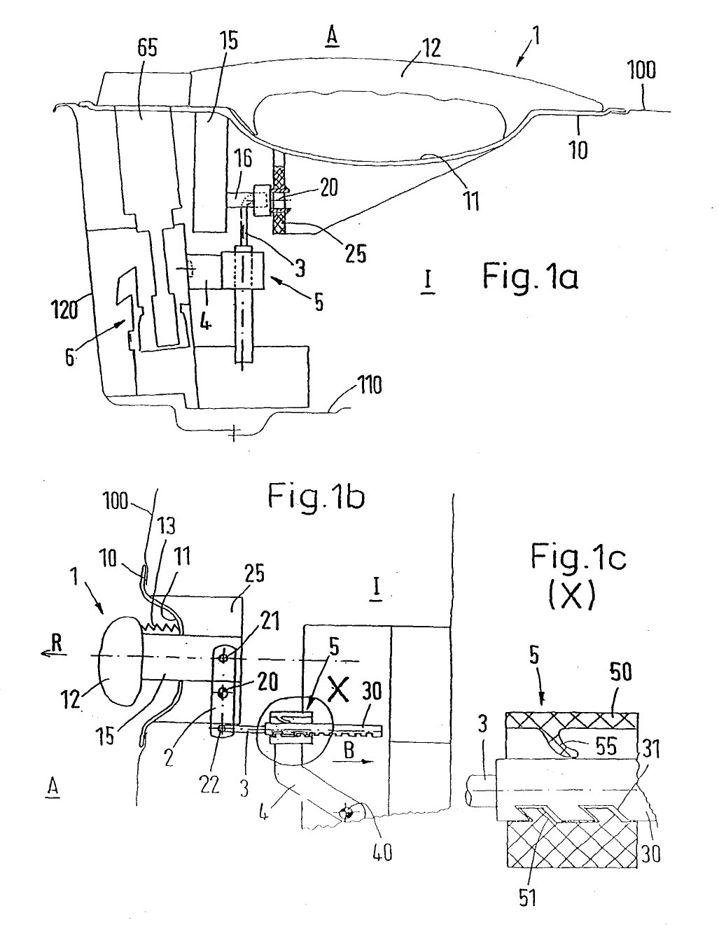

FIGS. 1a to 1c show an embodiment of a closing device for a vehicle door, in which an external door handle is connected through a double-armed lever and a slide bar to an operating lever of a door lock wherein distance compensating means are mounted between the slide bar and the operating lever;

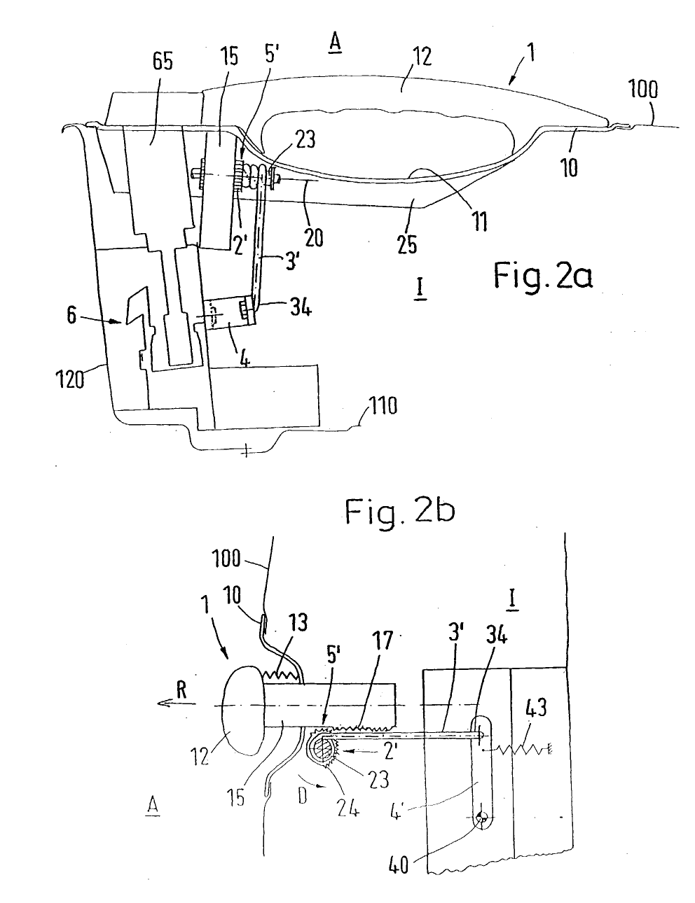

FIGS. 2a to 2b show an embodiment of a closing device for a vehicle door in which an exterior door handle is coupled through a rotatably mounted roller and a cable to the operating lever of a door lock wherein the cable can be unwound from the roller for distance compensation;

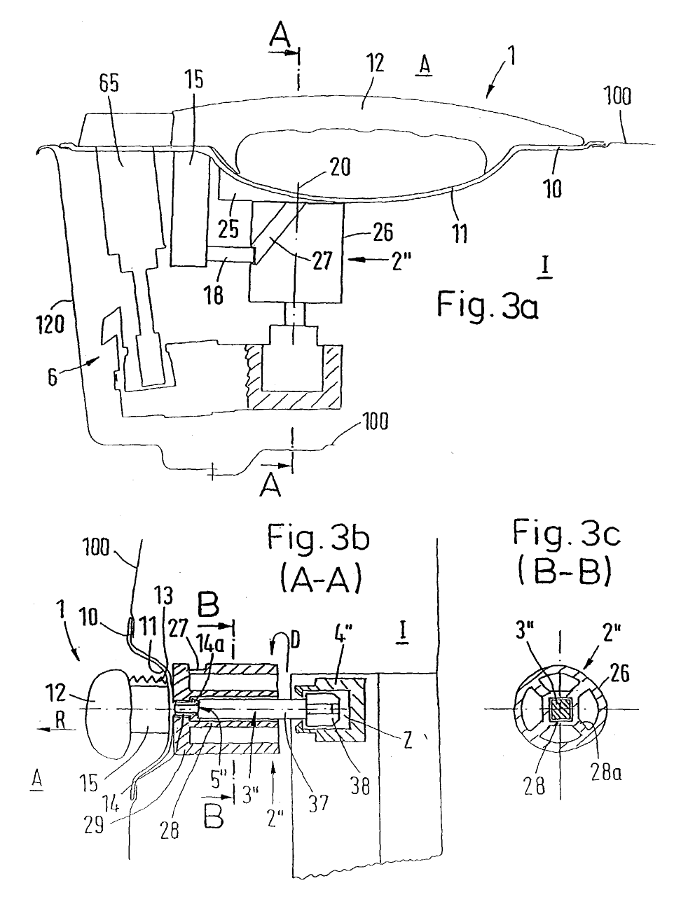

FIGS. 3a to 3c show an embodiment of a closing device for a motor vehicle door in which the exterior door handle acts through a rotatably mounted roller and coupling rod connected rotationally secured therewith on a lock follower of a door lock wherein the coupling rod has a telescopic design for distance compensation.

In FIGS. 1a to 1c an external door actuator 1 is shown fixed on the exterior skin 100 of a motor vehicle door. This door actuator has an exterior handle 12 attached for swivel movement to the exterior skin 100 and connected to same through a handle dish 10 provided with a handle indent 11.

The handle 12 is pretensioned by a spring element 13 shown diagrammatically in FIG. 1b towards the exterior skin 100 or handle indent 11 and in order to open the vehicle door (when the door lock is unlocked) has to be pulled outwards against the pretension of the spring element 13 (Direction R).

Next to the exterior handle 12 on the exterior skin 100 of the vehicle door is a locking cylinder 65 which is connected to the door lock 6 which is provided in the region of an end side 120 of the door body (or more precisely of an inner door panel). The inner door panel extends up to a door module support 110 which is fixed on the inner door panel and which serves to hold various function components of the vehicle door.

The exterior door handle 12 has a projection 15 which projects into the interior I of the vehicle door (i.e. the space between the exterior skin 100 and the inner panel or door module support 110) and which when the exterior handle 12 is actuated is moved together with the exterior handle 12 towards the exterior door space A. The end of the projection 15 remote from the external door handle 12 is connected for articulated movement at the articulation point 21 to a deflecting element in the form of a double-armed deflecting lever 2. The deflecting lever 2 is mounted for swivel movement about an axis 20 on a bearing block 25 of the handle dish 10 projecting into the interior space I of the vehicle door. The deflecting lever 2 is connected by its second lever arm to a coupling element 3 in the form of a slide bar through an articulation point 22.

The slide bar 3 has a toothed section 30 which is provided with inclined teeth 31. Through this toothed section 30 the slide bar 3 is in engagement with a sleeve 50 which has an internal toothing 51 corresponding to the inclined toothing 31. The sleeve 50 is provided on its side facing away from the toothing 51 with an integral elastic element 55 which acts on the toothed section 30 of the slide bar 3 so that it engages continuously with the toothing 51 of the sleeve. The two toothed sections 31, 51 of the slide bar 3 on the one side and the sleeve 50 on the other form a ratchet coupling or detent coupling which enables movement of the slide bar 3 relative to the sleeve 50 (against the action of the elastic section 55) towards the exterior space A of the vehicle, but during movement of the slide bar 3 in the opposite direction B however ensures that the sleeve 50 is entrained by the slide bar 3 or its toothed section 30.

The sleeve 50 is in turn connected (in one piece or through additional fastening means) to an external operating lever 4 of the door lock mounted for swivel movement about an axis 40. The vehicle door can be opened (when the door lock 6 is unlocked) by swivelling the external operating lever 4. This takes place in detail as follows: In order to open the vehicle door the external handle 12 is drawn against the pretension of the spring element 13 along a direction R away from the external skin 100 of the vehicle door. The external handle 12 hereby acts through its projection 15 on the deflecting lever 2. This converts the pulling movement of the external handle 12 into a pushing movement of the slide bar 3 in the opposite direction B. The slide bar 3 hereby entrains the sleeve 50 which results in swivel movement of the external operating lever 4 about its axis 40. This enables the vehicle door to be opened in known way.

If a crash situation (for example a front impact crash) leads to compression of the external skin 100 of the vehicle door then it can result in a movement of the external handle 12 as well as the deflecting element 2 towards the exterior space A. The external handle 12 and the deflecting lever 2 thereby move substantially in unison since they are both connected to the exterior skin 100 of the vehicle door through a common supporting part (handle dish 10). As the deflecting element 2 moves in the direction R of the exterior space A the slide bar 3 is entrained by the deflecting lever 2 in this direction R. This movement is however not transferred to the deflecting lever 4 since the slide bar 3 can move in the said direction R relative to the sleeve 50 of the external operating lever 4. As a result of the special configuration of the inclined teeth 31, 51 the sleeve 50 thus acts on the slide bar 3 on one side and the sleeve 51 on the other side as distance compensating means 5 which permit movement of the deflecting element 2 as well as the coupling element 3 relative to the external operating lever 4 in the direction R of the external space A.

It is hereby still of importance if the pretensioning force of the spring element 13 through which the external handle 12 is pretensioned towards the handle dish 10 is greater than the pretensioning force of the elastic element 55 which pretensions the inclined toothing 31 of the slide bar 3 in the direction of the associated toothing 51 of the sleeve 50. It is hereby ensured that with a crash-conditioned movement of the external door handle 12 outwards this does not result in relative movement of the external operating lever 4 inwards (direction B) in relation to the external handle 12 which would lead to the vehicle door opening.

The distance compensating means 5 thus enable a compensation of crash-conditioned distance changes between the external door handle 12 and the deflecting lever 2 on the one hand and the external operating lever 4 on the other hand without the risk of a crash-conditioned opening of the vehicle door (since the deflecting lever 2 or its swivel axis 20 is moved together with the external door handle 12).

If the length of the toothed section 30 of the slide bar 3 is made sufficiently long then this still remains in engagement with the toothing 51 of the sleeve 50 even at the end of a crash process and after distance compensation. This ensures that even after a crash the vehicle door can be opened by means of the external handle 12 and the associated gearing elements 2, 3, 4, 5.

In order to assemble the closing device illustrated in FIGS. 1a to 1c the slide bar 3 is preferably pre-fitted together with the deflecting element 2 on the projection 15 of the external door handle 12. The toothed section 30 of the slide bar 3 can then be inserted in simple manner through the opening in the external skin 100 provided to receive the handle dish and into the sleeve 50. Access from inside the vehicle to the component parts which are to be connected is not necessary. Assembly is therefore readily possible even if the external actuator 1 is only then fitted after a door module has been mounted on the inner door panel so that the closing device is no longer (or only under difficult conditions) accessible from inside the vehicle.

FIGS. 2a and 2b show a modification of the closing device of FIGS. 1a to 1c wherein matching component parts are provided with the same reference numerals and will not be explained in further detail below.

With the embodiment according to FIGS. 2a and 2b the projection 15 of the external handle 12 has a longitudinal toothing 17 which engages with an external toothing 24 of a guide pulley 2′ which is mounted in the region of the handle dish 10, rotatably directly on the external door skin 100 or on a projection of the handle shell 10. The pulley 2′ which is rotatable about an axis 20 forms a winding element on whose winding face 23 a flexible element 3′ (e.g. in the form of a wire or cable or belt) is wound up under pretension and which is fixed by its end 34 facing away from the pulley 2′ on an external operating lever 4′ which is mounted for swivel movement on the door lock.

In order to hold the wire 3′ under tension a pretension torsion spring (not shown in FIGS. 2a and 2b) can be mounted by way of example on the winding axis 20.

In order to open the vehicle door—as already explained re the previous embodiment—the external handle 12 is moved in the direction R towards the exterior space A of the vehicle whereby the projection 15 interacts through its longitudinal toothing 17 with the external toothing 24 of the pulley 2′ and generates a rotational movement D of the pulley 2′. The wire 3′ is hereby wound onto the winding face 23 of the pulley 2′ and the external operating lever 4′ of the door lock is swivelled out of its rest position against the action of a spring element 43 (tension spring) so that the door can open.

The spring element 13 acting on the external handle 12, the torsion spring which is to be mounted where necessary on the winding axis 20 and the spring element 43 which acts on the external operating lever 4′ are hereby matched with each other so that the external operating lever 4′ in the absence of external force action on the external handle 12 is located in its rest position (see FIG. 2b) from which it has to be swivelled out in order to open the door by means of the external handle 12. More particularly the resetting force of the spring element 43 acting on the external operating lever 4′ has to be sufficiently great compared with the force generated by the torsion spring.

If on the other hand the external door handle 12, the projection 15 and the pulley 2′ move in unison outwards as a result of a crash-conditioned compression of the external skin 100 of the vehicle door, then the wire 3′ is unwound from the pulley 2′ (since the longitudinal toothing 17 of the projection 15 does not act on the external toothing 24 of the pulley 2′) so that it does not result in any swivelling of the external operating lever 4′. It is hereby avoided that the vehicle door with a crash-conditioned deformation of the external skin 100 opens unintentionally outwards.

The pulley 2′ and the wire 3′ here form means for distance compensation which enable a movement of the external handle 12, projection 15 and pulley 2′ outwards without leading to a swivel movement of the external operating lever 4′.

Furthermore the door can still be opened even after a crash by means of the external handle 12 if as before a piece of wire is wound up onto the winding surface 23 of the pulley 2′.

If in the event of a crash there is a deformation of the external door skin 100 inwards then a distance compensation readily takes place between the pulley 2′ and the external operating lever 4′ in that the tension is released from the wire 3′ and this is wound up onto the winding face 23 of the pulley 2′. Also here it is ensured that after a crash the vehicle door can be opened further by means of the external handle 12.

Also with the present embodiment assembly is readily possible from the exterior space; for only the wire 3′ is to be fixed at one end of the external operating lever 4′ which can happen through the opening provided in the external skin 100 for receiving the handle indent 10. Also here no access from the interior of the vehicle is necessary for assembly.

FIGS. 3a to 3c show a further embodiment of a closing device in which as with the embodiment according to FIGS. 2a and 2b a movement of the external handle 12 in the direction R of the external space of the vehicle is converted into a rotary movement. For this purpose the projection 15 provided on the external handle 12 is provided with a nose 189 which engages in a guide groove 27 of a pulley 2″ of cylindrical outer contour 26 mounted rotatable on a bearing block 25 of the handle dish 10. The guide groove 27 thereby runs inclined to the cylindrical contour 256 of the pulley 2″ so that a movement of the external handle 12 and thus the projection 15 as well as the nose 18 in the direction R of the external space A of the vehicle is converted into a rotational movement D of the pulley 2′ about its axis 20.

A coupling element 3″ is mounted in the form of a coupling rod rotationally secured in the rotatably mounted pulley 2″ where it engages by a front section 38 into a lock follower 4″ of the door lock. For a rotationally secured mounting of the coupling element 3″ the pulley 2″ has a polygonal inner edge 28 (here in the form of a square edge) which is connected through webs 28a to the cylindrical outer contour 26 of the pulley 2″. The polygonal inner edge 28 interacts with a corresponding rectangular section of the coupling element 3″.

The lock follower 4″ in turn is in active connection with the door lock 6 so that the door can be opened (when the door lock is unlocked) by actuating the lock follower 4″ by means of the external handle 12 whereby the coupling element 3″ acts in the manner described above on the lock follower 4″.

According to the invention the coupling element 3″ is here formed as a telescopic coupling rod; for it is formed by a rod 37 which is movable (longitudinally displaceable) telescopically in the polygonal inner edge 28. The coupling element 3″ is thereby adjoined in the region of the handle indent 11 by a projection 14 of the handle dish 10. This projection 14 serves as a bearing for the pulley 2″ and has a widened end section 14a for axially securing the pulley 2″.

The coupling element 3″ in the form of a rod 37 engages positively in the polygonal inner edge 28 of the pulley 2″ so that it is entrained during rotary movement and can act by its front end section 38 on the lock follower 4″.

If in the event of a crash situation the external door skin 100 is compressed so that the handle dish 10 moves outwards then the external handle 12 with the projection 15, and the projection 14 provided on the handle dish 10 move together with the pulley 2″. As a result of the common movement of the projection 15 with the nose 18 on the one hand and the pulley 2″ with the guide groove 27 on the other, this does not result in a rotational movement of the pulley 2″.

At the same time during the movement of the pulley 2″ outwards its distance from the lock follower 4″ is changed. This change in distance is compensated in that the coupling element 3″ executes a relative movement in respect of the pulley 2″ whereby the effective length of the coupling element 3″ is increased. This relative movement is thereby possible since the rod 37 of the coupling element 3″ is mounted longitudinally displaceable in the pulley 2″.

In short, through the closing device illustrated in FIGS. 3a to 3c in the event of deformation of the external skin 100 in the direction R of the exterior space the generation of a rotational movement of the pulley 2″ which could result in unintended opening of the vehicle door, is now prevented. For this the pulley 2″ moves outwards together with the external handle 12 and its projection 15. The change in the distance between the pulley 2″ and the lock follower 4″ which is hereby caused is compensated by the telescopic coupling element 3″.

In the event of deformation of the external skin 100 inwards the projection 15 and the nose 18 provided therein likewise move together with the pulley 2″ which is mounted rotatable on the handle dish 10. The distance between the pulley 2″ and the lock follower 4″ is hereby reduced. The change in distance is compensated in that the end section 38 of the coupling element 3″ associated with the lock follower 4″ is mounted with sufficient axial play Z in the lock follower 4″ so that the coupling element 3″ can move for distance compensation axially in the direction of the vehicle interior. Thus the distance compensation means 5″ enable in the present case a distance compensation both in the event of deformation of the external skin 100 outwards and in the event of deformation inwards.

Also in this case, after a crash, actuation of the lock follower 4″ for opening the vehicle door by means of the external handle 12 is possible since the front end section 38 of the coupling element 3″ is located as before in engagement with the lock follower 4″.

Fitting the closing device can—as with the previous embodiment—be carried out through the opening provided in the external skin 100 of the vehicle door for receiving the handle dish 10. The front end section 38 of the coupling element 3″ is hereby to be brought into engagement with the lock follower 4″. Further assembly steps are not required since the external actuation 1, the deflecting element 2″ and the coupling element 3″ can be supplied as a finished prefitted module.

An essential common feature of all the embodiments is that the relative movement is carried out between each two elements (deflecting element 2, 2′, 2″ on the one hand and external operating lever 4, 4′, 4″ on the other) of the closing device which serve directly for force transfer from the external handle to the door lock.

Furthermore with all the embodiments the means 5, 5′, 5″ for compensating distance in a crash situation can also serve at the same time as means for compensating tolerance during assembly.

1. Closing device for a vehicle door with
a door lock
at least one actuating element (4, 4′,4″) for actuating the door lock
an external door actuator (12) which is fixed on the external skin (100) of the vehicle door and which has an adjuster part (15) which when the external door actuator (12) is operated moves along a first direction
a force transfer device through which the external door actuator (1) is coupled to the actuating element (4, 4′, 4″)
at least one deflector element (2, 2′, 2″) of the force transfer device which converts a movement of the adjuster part (15) along the first direction (R) in to a movement along a second direction (B, D) and
at least one coupling element (3, 3′, 3″) of the force transfer device through which the deflector element (2, 2′, 2″) acts on the operating element (4, 4′, 4″)
whereby the coupling element (3, 3′, 3″) is provided with or interacts with distance compensation means (5, 5′, 5″) which enable a movement of the deflector element (2, 2′, 2″) relative to the operating element (4, 4′, 4″)
and wherein the external door actuator (12) and the deflector element (2, 2′, 2″) are connected to the external skin (100) of the vehicle door so that if the external skin (100) is deformed they move in unison and
that the distance compensation means (5, 5′, 5″) only enable a movement of the deflector element (2, 2′, 2″) relative to the operating element (4, 4′, 4″) in the event of a change in the position of the deflector element (2, 2′, 2″) together with the external door actuator (12) as a result of deformation of the exterior skin (100)
characterised in that
a) the external door actuator (12) is attached at one end of a guide lever (2) mounted in a door handle dish (10) and a ratchet coupling (5) is switched in between the other end of the guide lever (2) and a lever-type lock operator, or
b) the door handle (12) is provided with a toothed rod (17) which when the door handle (12) is operated comes into engagement with a pinion (24) of a torsion-spring-tensioned cable pulley (2′, 23) in the handle dish (10) whose cable is connected to a lock operator (4′) whereby the toothed rod (17) and pinion (24) otherwise remain out of engagement, or
c) the door handle (12) is provided with a projection (15) on which a nose (18) is formed which engages in a guide groove (27) which is formed with an incline relative to the axis on the cylinder sleeve of a pulley (2″) mounted in the door handle dish (10), and wherein a coupling rod (37) is mounted coaxial, with keyed engagement and axially displaceable in the pulley (2″) and is connected to a rotationally moved lock actuation (4″).

2. Closing device according to claim 1 characterised in that the deflector element (2, 2″, 2″) and the coupling element (3, 3′, 3″) are formed by separate component parts or structural groups which are in active connection with each other.

3. Closing device according to claim 1 or 2 characterised in that the deflector element (2, 2′, 2″) is rigid.

4. Closing device according to one of the preceding claims characterised in that the deflector element (2, 2′, 2″) is mounted for swivel movement.

5. Closing device according to claim 4 characterised in that a pulling movement is converted into a pushing movement or a pushing movement is converted into a pulling movement through the deflector element (2).

6. Closing device according to claim 4 or 5 characterised in that the deflector element (2) is formed by a double-armed lever whereby the adjuster part (15) engages on one arm and the coupling element (3) engages on the other arm.

7. Closing device according to claim 4 characterised in that a linear movement of the adjuster part (15) along the first direction (R) is converted by the deflector element (2′, 2″) into a rotary movement (D) of the deflector element (2,2′).

8. Closing device according to claim 4 or 7 characterised in that the deflector element (2′, 2″) is formed by a pulley which is rotatable through a movement of the adjuster part (15) along the first direction (R).

9. Closing device according to claim 8 characterised in that the deflector element (2′, 2″) is coupled to the adjuster part (15) in the manner or a toothed rod gearing (17, 24) or through the interaction of a guide element (18) with a guide sleeve (27) for generating a rotary movement.

10. Closing device according to claim 8 or 9 characterised in that the pulley (2′) is formed as a winding element on which a coupling element (3′) formed as a wind-up tension means can be wound and unwound.

11. Closing device according to claim 8 or 9 characterised in that the pulley (2″) has a socket (28) for the rotationally secured holding of the coupling element (3″).
